(19) United States
(12) Patent Application Publication
(10) Pub. No.: US 2013/0056408 A1
(43) Pub. Date: Mar. 7, 2013

(54) FUEL FILTER DEVICE

(71) Applicants: Peter Buchner, Oberriexingen (DE); Carlos Holtnagel, Winnenden (DE); Jürgen Orlich, Herrenberg (DE); Harry Wolf, Uhingen (DE)

(72) Inventors: Peter Buchner, Oberriexingen (DE); Carlos Holtnagel, Winnenden (DE); Jürgen Orlich, Herrenberg (DE); Harry Wolf, Uhingen (DE)

(21) Appl. No.: 13/621,251

(22) Filed: Sep. 16, 2012

(30) Foreign Application Priority Data
Mar. 16, 2010 (DE) 10 2010 011 558.4

(51) Int. Cl. B01D 35/157

(52) U.S. Cl. 210/418

(57) ABSTRACT

In a fuel filter device, in particular for diesel fuel, including a housing, which has a receiving chamber for a medium to be separated from the fuel, a valve device is provided which can be moved between a closed position closing the receiving chamber and an open position opening up the receiving chamber for the removal of the medium from the receiving chamber, the valve device comprises a valve member, which is so arranged that it is biased by the medium in the receiving chamber into the closed position, the medium pressure being exerted on a surface at the valve member for keeping the valve member in its closed position.

This is a Continuation-In-Part application of pending international patent application PCT/EP2010/007418 filed 7 Dec. 2010 and claiming the priority of German patent application 10 2010 011 558.4 filed 16 Mar. 2010.

### BACKGROUND OF THE INVENTION

The invention relates to a fuel filter device, in particular for Diesel fuel, including a housing with a valve at the bottom end thereof for releasing a medium, in particular water separated from the fuel.

DE 198 04 549 A1 discloses a fuel filter, especially for diesel fuel, with a filter housing, which has an inlet port and an outlet port and, in its interior, holds a filter cartridge, which is connected between the two ports in a way separating the sludge and the clean side from one another. A water chamber is formed in the lower part of the filter housing, into which a water sensor extends and from which water can be drained through a water drain connection to the outside via a valve which is mechanically operated from the outside. The mechanically adjustable valve in this case can be operated via a cable.

The known fuel filter has the disadvantage that leakages may occur, as a result of Which water contained in the water chamber can escape uncontrollably from the water chamber in an undesirable way.

It is therefore the principal object of the present invention to provide an improved fuel filter device in which the risk of such leakages is at least reduced.

### SUMMARY OF THE INVENTION

In a fuel filter device, in particular for diesel fuel, including a housing, which has a receiving chamber for a medium, to be separated from the fuel, wherein a valve device is provided which can be actuated between a closed position closing the receiving chamber and an open position opening up the receiving chamber for the removal of the medium from the receiving chamber, the valve device comprises a valve member, which is so arranged that it is biased by the medium into the closed position, the pressure being exerted on a surface of the valve member for keeping the valve member in its closed position.

The valve is a self-energizing valve, which means that the higher the pressure of the medium on the surface, the higher the force resulting therefrom on the valve and the better it seals the receiving chamber against escape of the medium therefrom. In comparison to the state of the art rising pressure of the medium consequently does not cause a degradation of the sealing function of the valve but even an enhancement as a result of which a risk of leakage, whereby the medium could leak uncontrollably from the receiving chamber to the environment, is at least reduced or avoided.

If escape of the medium from the receiving chamber to the outside is desired, for example when a certain filling height is reached and thus draining of the receiving chamber is necessary, the valve can be brought in a simple manner from the closed position into the open position, as a result of which the medium can leave the receiving chamber. This is advantageously carried out by gravity, as a result of which additional pump devices are avoided. This means that the valve device as well as the valve and an opening, from which the medium can flow from the receiving chamber aligned with the fuel filter device in the assembly position, in which the fuel filter device is integrated, are arranged at the bottom, particularly at the deepest point of the receiving chamber, as a result of which the medium can escape automatically from the receiving chamber under the effect of gravity.

To enhance the sealing effect of the valve, at least one sealing element is disposed between the valve and a respective valve seat. If the medium presses the valve towards the valve seat, the sealing element located in this region is also compressed and causes the receiving chamber to be particularly well sealed to prevent uncontrolled escape of the medium therefrom.

If the valve, at least in regions, extends into the receiving chamber, the resultant very good sealing function is generally associated with an extremely compact design of the fuel filter device, which contributes to the avoidance and solution of packaging problems, particularly in a space-critical area such as the engine compartment, where the fuel filter device advantageously can be, and generally is, installed.

In an advantageous embodiment of the invention the valve can be moved via a cable between the closed position and the open position from a location, which is at a certain, in particular large, distance from the valve device and/or the fuel filter device. The inventive fuel filter device is usually arranged particularly close to a corresponding internal combustion engine, especially a diesel engine and other components. The control of the valve via the cable permits the positioning of an operating element for operating the cable and thus of the valve in a region, which advantageously a person, particularly a mechanic or the like, can easily and ergonomically access.

The cable in this case is connected at one end at least indirectly to the valve. At the other end it is connected for example to a rotary knob, so that a rotation in one direction of the rotary knob causes a pulling on the cable, which in turn is converted into an adjustment movement of the valve device. The cable for example is connected to the valve via a lever element, as a result of which a pulling of the cable is converted into a pressing of the lever element onto the valve, so that the valve can be moved from the closed position to the open position.

The reverse adjustment of the valve, thus from the open position to the closed position, in this case is carried out for example by gravity which, if the receiving chamber is empty, moves the valve towards the valve seat, as a result of which the valve in turn presses on the lever element, which in turn moves the cable into a normal, closed position. The cable then again rotates the rotary knob into a corresponding normal position. Subsequently, again by rotating the rotary knob, a pulling of the cable and the lever element is possible and thus a movement of the valve from the closed position to the open position.

The adjustment of the valve device from the at least one open position into the closed position as well as the adjustment of the lever element and/or the cable and/or the rotary knob into the respective normal position in this case can be assisted by at least one spring element, which during the adjustment of the valve from the closed position into the at least one open position is tightened and thereby tensioned, and which then, due to its spring force, causes or at least assists the adjustment into the closed position or the respective normal position.

In any case, the inventive fuel filter device makes it possible for water contained in the fuel, particularly diesel fuel, to be separated, no matter what the water content in the fuel is which varies with the fuel quality. This water accumulates in the receiving chamber and must be drained, at certain intervals in order to avoid damage to the fuel system. Since the fuel system is under pressure, leakages are undesirable at any point in time or under any operating condition. Such a leakage results in the water uncontrollably entering the environment and possibly causing contamination. In the worst case a corresponding motorcar or a corresponding road vehicle may be damaged by uncontrolled escape, since perhaps for example with such undesirable leakage, not only water but also fuel can escape, if no other precautions are taken. This risk of undesirable leakage is at least substantially reduced, if not even prevented, by the inventive fuel filter device. In addition the inventive fuel filter device facilitates the control of the valve.

The invention will become more readily apparent from the following description of an exemplary embodiment thereof with reference to the accompanying drawings. The features and feature combinations mentioned in the description as well as those specified below in the figure description can be used also in other combinations or on their own, without departing from the concept of the invention.

### BRIEF DESCRIPTION OF THE DRAWINGS

FIG. 1 is a partial view of an embodiment of the inventive fuel filter device with a valve device, which is in a closed position;

FIG. 2 is a partial view of the fuel filter device according to FIG. 1, with the valve device in an open position;

FIG. 3 is a part perspective view of a rotary knob of the fuel filter device in accordance with the above figures, by means of which the valve device can be operated;

FIG. 4 is a profile view of the rotary knob according to FIG. 3;

FIG. 5 is a partial perspective view of the filter device according to the above figures; and

FIG. 6 a perspective view of the fuel filter device according to the above figures.

### DESCRIPTION OF AN EXEMPLARY EMBODIMENT

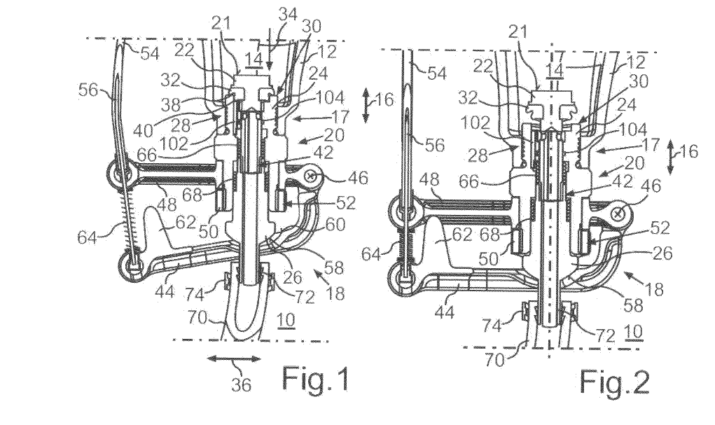

FIGS. 1 and 2 show a filter device 10 for diesel fuel with a housing 12. The housing 12 has a receiving chamber 14, which is arranged in the vertical direction of the fuel filter device 10 as indicated by the directional arrow 16 in a lower area of the fuel filter device 10, and an opening 17.

Water, separated from the diesel fuel, can be drained from the housing 12 that is from the receiving chamber 14 via the opening 17 and thereby removed from the fuel filter device 10.

To ensure a controlled removal of the water from the receiving chamber 14 and to avoid leakages of the fuel filter device 10, the fuel filter device 10 comprises a valve device 18, which can be adjusted between a closed position closing the receiving chamber 14 and an open position releasing the content of the receiving chamber 14. The closed position in this case is shown in FIG. 1 and the open position 1 shown in FIG. 2.

As evident from FIGS. 1 and 2, the valve device 18 comprises a valve 20, which in turn comprises a first valve part 22, a second valve part 24 as well as a third valve part 26. The second valve part 24 is permanently connected to the housing 12 via a respective thread 28 and forms a valve seat 30 for the valve part 22 which can be moved in the vertical direction of the fuel filter device 10 between the closed position indicated in FIG. 1 and the open position indicated in FIG. 2 as indicated by the directional arrow 16. A sealing element 32 is disposed between the valve seat 30 and the valve part 22. If water is present in the receiving chamber 14, the pressure of this water thus presses this water according to a directional arrow 34 onto a surface 21 of the valve part 22 and therefore the valve 20 into the closed position. With rising pressure in the receiving chamber 14 a force acting according to the directional arrow 34 on the surface 21 and the valve 20 also rises, as a result of which the valve part 22 and thus the valve 20 are pressed even more heavily into the closed position. Therefore a self-energizing valve 20 is provided, the sealing function of which increases with rising pressure in the receiving chamber 14 and does not decrease for instance with rising pressure in the receiving chamber 14. As a result the fuel filter device 10 provides good protection against undesirable leakages and undesirable escape of the water or a medium from the receiving chamber 14.

To enhance the sealing function of the valve 20 both a sealing contact 38 extending in the radial direction according to a directional arrow 36 and a sealing contact 40 extending in the axial direction of the valve 20 according to the directional arrow 16 are formed between the sealing element 32 and the valve seat 30 or the valve part 24. These redundant sealing contacts 38 and 40 result in the protection against uncontrolled escape of the water or medium contained in the receiving chamber 14 being further increased.

If draining of the water is desired, the valve 20 can be moved from the closed position into at least one open position, in which the water can escape from the receiving chamber 14 via the opening 17. For this purpose the valve part 22 is connected to the valve part 26 by a thread 42. The valve part 26 can now be operated via a lever element 44, by means of which the valve 20 or the valve parts 22 and 26 can therefore be pressed upwards in the vertical direction according to the directional arrow 16, as a result of which valve part 22 and the sealing element 32 lift off from the valve seat 30 and thus allow the liquid to escape from the receiving chamber 14. The lever element 11 in this case is pivotally mounted about a swivel axis 46 on a retaining element 48 of the valve device 18. The retaining element 48 is thereby permanently connected to the valve device 18 fitted on the valve part 24 and by means of a nut 50 can be positioned into a desired position along the upper direction according to the directional arrow 16.

Thus while the lever element 44 in the open position engages the surface 58 of the valve part 26, in the closed position of the valve 20 the surface 60 of the lever element 44 is spaced apart from the surface 58 of the valve part 26.

During the movement of the valve 20 or valve device 18 from the closed position to the open position, the valve parts 22 and 26 travel a distance of 4 millimeters for example in the vertical direction indicated by the directional arrow 16.

The nut 50 is connected to the valve part 24 by a respective thread 52, as a result of which the retaining element 48 can be moved into the desired position in a vertical direction as indicated by the directional arrow 16.

In order to facilitate trouble-free draining of the water from the receiving chamber 14 to the outside, the valve device 18 has a breather 102, through which air can enter the receiving chamber 14 when the water is being drained from the receiving chamber 14 to the outside in order to permit a smooth volume exchange. Moreover a further sealing element 104 is provided which seals the valve part 22 and the valve part 24.

A cable 56, partly ducted in a cable sleeve 54, which pulls the lever element 44 upwards in the vertical direction, is connected to the lever element 44, for lifting the valve parts 22 and 26 of the valve 20. Thus the lever element 44 engages the valve parts 22 and 26 over correspondingly cooperating surfaces 58 and 60 to move it from the closed position of the valve device 18 indicated in FIG. 1 to the open position of the valve device 18 indicated in FIG. 2. To prevent the lever element 44 from being moved too far, it has a stop element 62 which, when the open position is reached, abuts a corresponding region of the retaining element 48 and prevents any further pivoting of the lever element 44 as well as any further movement of the cable 56.

As evident from FIGS. 1 and 2, the cable 56 is guided in a corresponding region of the retaining element 48. Additionally a spring element 64 is provided, which on the one hand is supported by the cable 56 and on the other hand b the retaining, element 48. During an adjustment of the valve device 18 or the valve 20 from the closed position into the open position, the spring element 64 is compressed and therefore tensioned. After the water has been drained from the receiving chamber 14 via the passage 17, the spring element 64 an presses the cable as well as the lever element 64 from the respective upper end position into a normal position indicated in FIG. 1. Moreover the spring element 64 acts as clamping element in order to at least reduce any vibration as well as premature wear of the lever element 44 and the cable 56.

The valve 20 or the valve parts 22 and 26 are correspondingly returned from the open position into the closed position by means of two further spring elements 66 and 68, which likewise are tensioned during the movement of the valve 20 from the closed position into the open position and, after draining has been completed, press the valve 20, due to this being subjected to the spring force, back into the closed position. Two spring elements 66 and 68 are provided, in order to create redundancy and to ensure a reliable sealing function of the valve 20 or valve device 18 in order to avoid leakages of the fuel filter device 10.

A hose 70, which is fitted to a corresponding port 72 of the valve part 26 and is secured against slipping by means of a hose clamp 74, is provided to drain the water or medium to be removed from the receiving chamber 14.

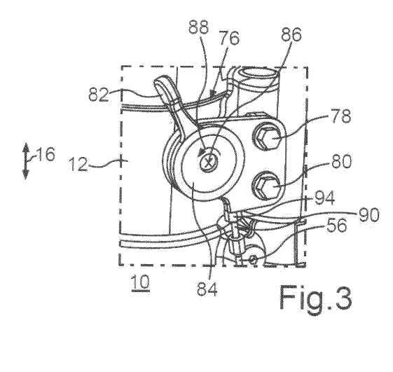

FIG. 3 shows a rotary knob 76 for the fuel filter device 10, which is fixed by means of screws 78 and 80 to the housing 12 of the fuel filter device 10. The rotary knob 76 comprises an actuation an 82 as well as a basic component 84, whereby by pressing or pulling the actuation part 82, the basic component 84 performs a rotary movement about a rotational axis 86 of the rotary knob 76. The cable 56 in this case is connected to the basic component 84 of the rotary knob 76, as a result of which a rotation of the basic component 84 according to a directional arrow 88 is converted into a pulling of the cable 56 upwards in the vertical direction according to the directional arrow 16. Thus the cable 56 also pulls the lever element 44 upwards, whereupon the lever element moves the valve 20 from the closed position into the open position. When the pressing or pulling of the rotary knob 76 has terminated, the spring elements 64, 66 and 68 mentioned in turn move the valve 20 into the closed position. Likewise in place of this automatic adjustment of the valve device 18 or the valve 20 from the open position into the closed position, due to the application of spring force via the spring elements 64, 66 and 68, the valve device 18 can be manually moved from the open position into the closed position. This is possible for example by a rotation of the rotary knob 76 in a direction opposite the direction indicated by the directional arrow 88.

In order to ensure that the cable 56 is free from play and thus to avoid vibration and wear, an adjusting screw 90 is provided, by means of which the cable 56 will always be kept under tension and with a rotation of the rotary knob 26, complete adjustment of the valve device 18 can be guaranteed.

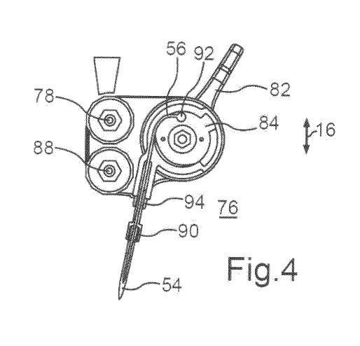

This is further clarified by the cutaway view of the rotary head 76 shown in FIG. 4. As evident, from FIG. 4, the cable 56 with a corresponding head 92 is held in a corresponding seat of the basic component 84 of the rotary knob 76 and is thus connected thereto in a slip-proof way. The adjusting screw 90 in this case is locked by a corresponding nut 94. Adjustment of the valve device 18 via the cable 56 and the rotary knob 76 permits trouble-free and ergonomically advantageous adjustment of the valve device 18, since the rotary knob 76 can be positioned in regions, which a person can particularly easily access. To further enhance this accessibility the actuation part 82 of the rotary knob 76 is spaced for example approx. 13 mm apart from the housing 12 of the fuel filter device 10. Due to this mechanical operation of the valve device 18 from a certain distance away, mechanical remote-controlled operation of the valve device 18 is implemented, which apart from the particularly good accessibility also provides the advantage of protection from splash-water.

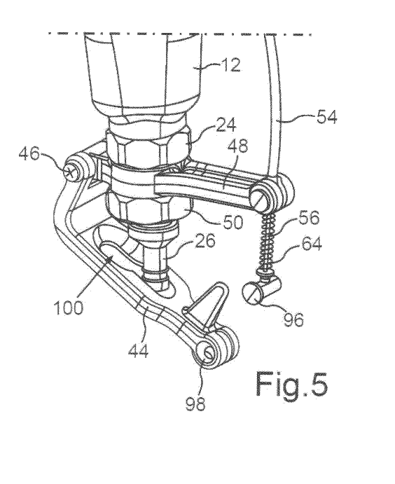

FIG. 5 clarifies the connection of the cable 56 to the lever element 44, wherein the cable 56, by means of a further head 96, is held in a corresponding seat 98 of the lever element 44 and is thus secured therewith.

As further evident from FIG. 5, the lever element has an opening 100, through which the valve part 26 can pass, as a result of which pivoting of the lever element 44 about the swivel axis 46 is facilitated. Additionally FIG. 5 clarifies that both the valve part 24 and the nut 50 have an external hexagon in each case, by means of which they can be screwed on via the corresponding thread 28 or 52. Also the valve part 26 has flattened regions, which for example can cooperate with a wrench, as a result of which the valve part 26 can also be screwed onto the valve part 22 via the respective thread 42.

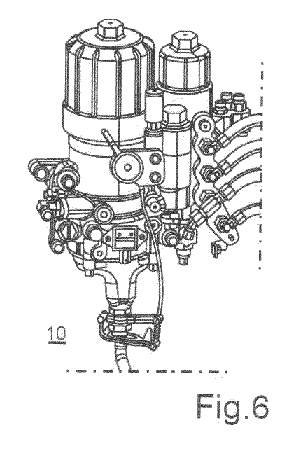

FIG. 6 shows the valve device 10 in a perspective view, from which the elements, construction parts and components detailed are evident.

As clarified by reference to FIGS. 1-6, the valve device 18 constitutes a module, which can be assembled separately and with which already existing fuel filter devices can be retro-fitted.

For assembling the valve device 18 first the sealing element 32 is connected to the valve part 22, whereupon the sealing element 104 is assembled. Then the valve part 22 with the sealing element 32 is introduced into the valve part 24, whereupon the spring elements 66 and 68 are arranged accordingly. Subsequently, the valve part 24 is introduced from a side, lying opposite the valve part 22, and screwed onto the valve part 26 via the respective thread 42. Subsequently the retaining element 48, which is already pivotally connected to the lever element 44, is pushed onto the valve part 24 and held in the desired position by screwing the nut 50 onto the valve part 24 via the respective thread 52. Subsequently the cable 56 is connected to the lever element 44; the hose 70 is fitted to the valve part 26 and secured with the hose clamp 74. Then the rotary knob 76 is assembled, the cable being connected to the basic component 84 and the rotary knob 76 being screwed onto the housing 12. Of course, the assembly steps detailed can also be carried out in a different sequence.

What is claimed is:

1. A fuel filter device (10) for filtering a fuel, in particular diesel fuel, comprising a housing (12) with a receiving chamber (14) for accumulating a medium separated from the fuel in the fuel filter device, and a valve device (18) with a closed position closing the receiving chamber and an open position opening the receiving chamber for removing the medium from the receiving chamber (14), the valve device (18) comprising a valve member (20), which can he pressed into the closed position by a pressure of the medium exerted on a surface (21) of the valve member (20) and a sealing element (32) disposed between the valve member (20) and a respective valve seat (30) forming a sealing contact (38, 40) and extending at least substantially in the axial direction of the valve (20) and also at least substantially in the radial direction of the valve (20) being formed in the closed position between the valve member (20) and the valve seat (30) or between the valve (20) and a sealing element (32) disposed between the valve member (20) and the valve seat (30).

2. The fuel filter device (10) according to claim 1, wherein the valve member (20) is movable by a cable (56) from the closed position to the open position upwardly against any closing pressure applied by the medium.

3. The fuel filter device (10) according to claim 2, wherein at least a first spring element (64), supported on the cable (56), is provided, against the spring force of which the cable (56) can be moved from the closed position to the open position.

4. The fuel filter device (10) according to claim 2, wherein a rotary knob (76) connected to the cable (56), is provided, by means of which the valve member (20) can be moved by the cable (56) from the closed position into the open position.

5. The fuel filter device (10) according to claim 1, wherein the valve member (20) can be moved from the closed position into the open position via a lever element (44) which is pivotally supported about a swivel axis (46).

6. The fuel filter device (10) according to claim 5, wherein the lever element (44) is pivotally supported on the fuel filter device (10), in particular on the valve device (18).

7. The fuel filter device (10) according to claim 1, wherein the surface (21) is formed on the valve member (20).

8. The fuel filter device (10) according claim 1, wherein a second spring element (66, 68) is supported on the valve (20), against the spring force of which the valve (20) can be moved from the closed position into the open position.
